(19) United States
(12) Patent Application Publication
(10) Pub. No.: US 2004/0172272 A1
(43) Pub. Date: Sep. 2, 2004

(54) Method and system for dynamically analyzing consumer feedback to determine project performance

(76) Inventors: Carol L. Shillinglaw, Waukesha, WI (US); Jie Xue, Pewaukee, WI (US); Michael A. Jones, Lake Forest, IL (US); Thomas J. Hook, Brookfield, WI (US)

Correspondence Address: Ziolkowski Patent Solutions Group, LLC, 14135 North Cedarburg Road, Mequon, WI, 53097, US

(21) Appl. No.: 10/749,452

(22) Filed: Dec. 31, 2003

Related U.S. Application Data
(63) Continuation of application No. 09/681,871, filed on Jun. 20, 2001, now abandoned.

(51) Int. Cl. G06F 17/60

(52) U.S. Cl. 705/1

(57) ABSTRACT

A system and method for dynamically monitoring consumer opinion of an implemented business integration includes a network of graphical user interfaces (GUI) in real-time or near real-time. The network of GUIs include an external GUI having a number of hyperlinks to feedback inputting GUIs. The feedback GUIs enable a consumer/user to provide objective and subjective data regarding his/her opinion of the implemented business plan. Feedback is routed to a centralized facility for processing and analysis to determine feedback characteristics. Those feedback characteristics are then displayed on an internal business integration GUI.

### BACKGROUND OF THE INVENTION

The present invention relates generally to monitoring project performance and, more particularly, to a method and system for dynamically analyzing consumer feedback to determine consumer opinion regarding an implemented business plan or integration.

In a fast-paced, ever-changing, complex market, the availability of information is paramount. Information drives short-term and long-term business decisions that ultimately affect the profitability and long-term existence of a business enterprise. A business enterprise that repeatedly relies on untimely or stale information not only jeopardizes its profitability, but its existence as a market competitor.

Typically, companies employ sophisticated technologies and techniques to acquire information on various market forces that affect their bottom-line, yet, invariably utilize archaic and slow information processing systems for the collection of internal and external information. Depending on the particular company, the freshness of the internal information or data may have a greater impact on the company's livelihood than the timeliness of external, general market, data.

To make sound business decisions, a review of both internal and external data is essential. External data may include information regarding market trends and a product's market share. Internal information, however, might include data regarding satisfaction of company objectives, both financial and operational, as well as consumer feedback regarding public opinion of implemented business plans in furtherance of those company objectives. For example, instituting a particular business plan may depend upon particular completion of a company project or task or in response to consumer identified needs. As a result of the complexity of the particular business plan, a certain period of lead-time is needed for proper and timely institution. With known business models, information regarding the completion of the required project or task filters through the proper chain of command until, ultimately, the right individual learns of the project status and perhaps completion. Unfortunately, these business models rely heavily on the relaying of information through the company bureaucracy. As a result, the information may be untimely when finally received by the decision making individual.

Moreover, these known methods of tracking project and/or task completion lack the sophistication needed for a globally competitive company. Increasingly, there are many corporations that employ thousands of individuals across several time zones with offices located in each corner of the globe. Oftentimes, these multinational corporations employ expensive and elaborate communication technologies to ease the strain of transpacific, transatlantic, and transcontinental communication, yet, do not eliminate the propensity for the untimely processing of internal information.

For example, current market trends include the business model of growth by acquisition. While the acquisition of a particular enterprise is a time consuming and costly endeavor, integration of the recently purchased company with the purchasing company can be a truly daunting task. Moreover, integrating an enterprise remotely located from the parent company is not only commonplace, but also certainly increases the cost as well as difficulty in assimilating the two companies. Furthermore, more than ever, the enterprise subject to integration will have its fair-share of remotely located offices, distributors, manufacturing facilities, and personnel. As a result, oversight and monitoring of the assimilation of the purchased enterprise with the purchasing company while maintaining fresh and timely information can be a truly cumbersome task.

Further, companies and business enterprises transfer information relating to a particular project, task, or business assimilation, for example, in a series of often-voluminous paper documents generated by many different individuals. To ascertain a completion status or monitor performance of the aforementioned project requires a manual sifting of these numerous documents. The difficulty in reviewing project performance or completion is exaggerated when the paper documents are generated at various remotely located offices. In fact, the mere accumulation of the data or information from the various offices for executive review requires significant processing time and at a substantial cost.

Moreover, company or business enterprise decisions affect consumers located throughout a geographical market. With the increasing growth of Internet-based enterprises and multi-national corporations, simply providing a forum for consumers to voice their opinions is no longer sufficient. Consumers want their opinions considered and often replied to in a timely and complete manner. Therefore, timely processing of consumer feedback is more challenging and important.

It would therefore be desirable to have a system and method capable of dynamically monitoring consumer feedback to determine consumer opinion of an implemented business plan. It would also be desirable to provide a forum wherein consumers can input feedback and have the feedback automatically routed to the appropriate individual for a timely and complete reply, if requested.

### SUMMARY OF THE INVENTION

The present invention provides a system and method of dynamically receiving and analyzing consumer feedback regarding an implemented business plan or integration to determine market opinion and thereby overcoming the aforementioned drawbacks.

In accordance with an aspect of the present invention, a method of dynamically monitoring external responses to a business plan is provided. The method includes the step of providing a graphical user interface (GUI) that is configured to enable user input of feedback related to the business plan. The method further includes the steps of receiving user feedback wherein the user feedback includes one or more user responses and routing the user feedback to a centralized facility. At the centralized facility, feedback characteristics of the user feedback are determined for subsequent displaying on an internal business plan GUI and then actually displaying the feedback characteristics on the business plan GUI in near-real time.

In accordance with another aspect of the present invention, a network system having a computerized network, a readable memory electronically linked to the network, a plurality of computers connected to the network, and a processing unit capable of calling a number of graphical user interfaces (GUI) are provided to monitor consumer opinion of an implemented business integration. The system includes a processing unit programmed to display an external GUI having at least one user response link. The processing unit is further programmed to display, upon user selection of the at least one user response link, at least one response GUI including a survey GUI. The processing unit is further programmed to receive a user response regarding an implemented business integration and transmit the user response to an integration leader. Upon authorization by the integration leader, the processing unit is programmed to display the user response on a summary GUI for the implemented business integration.

In a further embodiment of the present invention, a computer data signal is provided and embodied in a carrier wave and representing a sequence of instructions that, when executed by one or more computers, causes the one or more computers to display a first GUI having at least two hyperlinks thereon, one of the hyperlinks configured to display a second GUI upon a user selection thereof and the other hyperlink configured to display a third GUI upon user selection thereof. The second GUI is configured to enable a user to input feedback regarding an impact of an implemented business integration and the third GUI is configured to enable the user to request a response to the feedback. The sequence of instructions further causes the one or more computers to route the feedback and any request for a response, to a business integration leader and display at least a summary of the inputted feedback on a business integration graphical dashboard.

Various other features, objects and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is a representation of a graphical user interface (GUI) displaying a number of active integrations in accordance with the present invention;

FIG. 2 is a representation of an integration summary GUI in accordance with the present invention;

FIG. 3 is a representation of an integration functions GUI in accordance with the present invention;

FIG. 4 is a representation of an integration leader GUI in accordance with the present invention;

FIG. 5 is a representation a first integration initialization GUI in accordance with the present invention;

FIG. 6 is a representation of a second integration initialization GUI in accordance with the present invention;

FIG. 7 is a representation of a third integration initialization GUI in accordance with the present invention;

FIG. 8 is a representation of a definitional GUI in accordance with the present invention;

FIG. 9 is a representation of an input GUI configured to permit adding integration objectives to the GUI of FIG. 7;

FIG. 10 is a representation of a fourth integration initialization GUI in accordance with the present invention;

FIG. 11 is a representation of a definitional GUI in accordance with the present invention for providing definitional information regarding the integration objectives of FIG. 10;

FIG. 12 is a representation of an input GUI configured to permit adding of integration objectives to the GUI of FIG. 10;

FIG. 13 is a representation of a functional checklist GUI in accordance with the present invention;

FIGS. 14-16 are representations of a number of GUIs configured to permit updating of integration objectives;

FIG. 17 is a representation of a functional leader specific GUI in accordance with the present invention;

FIG. 18 is a representation of a GUI for adding a checklist item to the GUI of FIG. 13;

FIG. 19 is a representation of a GUI for adding a function task to the GUI of FIG. 13 in accordance with the present invention; and

FIG. 20 is a schematic block diagram showing the hardware layout of a system incorporating the present invention;

FIG. 21 is a representation of a GUI configured to enable consumer input/feedback in accordance with the present invention;

FIG. 22 is a representation of a GUI configured to enable consumer input of contact information in accordance with the present invention; and

FIG. 23 is a representation of a GUI configured to display a summary of consumer opinion and display selected consumer responses in accordance with the present invention.

### DETAILED DESCRIPTION OF THE PREFERRED EMBODIMENT

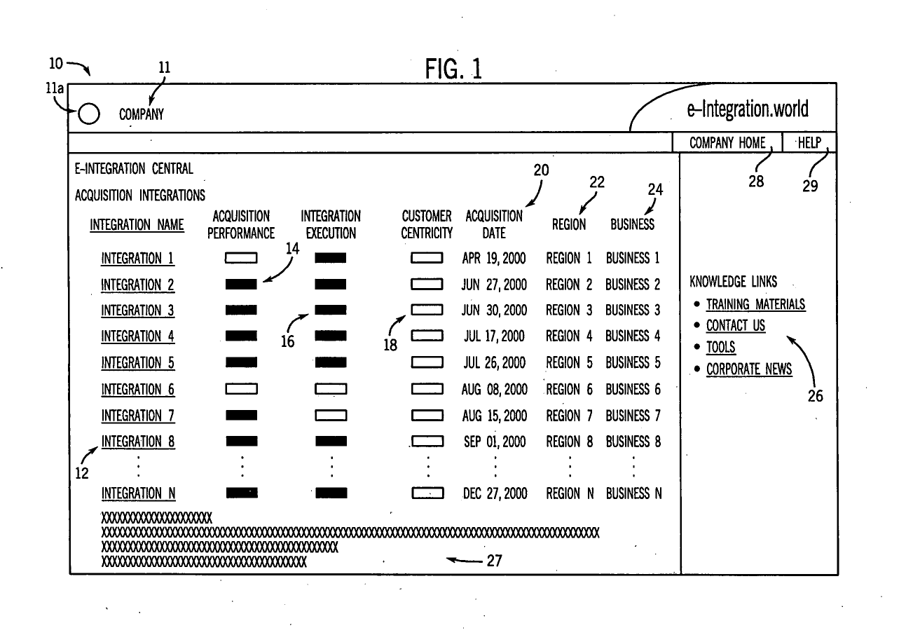

Referring to FIG. 1, an acquisitions central graphical user interface (GUI) 10 displays a number of active acquisitions 12 for a company 11. Corresponding to each active acquisition is a number of performance and/or status indicators, including an acquisition performance indicator bar 14 and an integration execution indicator bar 16. Each bar 14 and 16 is configured to color-code display a current performance status 14 and a current execution status 16. In a preferred embodiment, bars 14 and 16 are green during a favorable or acceptable status, yellow during a cautionary status, and red during an unfavorable or warning status. The parameters corresponding to a particular status are user-specific and may be varied to suit a particular need. For example, in a time dependent domain, indicator bars 14, 16 may reflect a completion status in comparison to the time remaining to complete the particular task or project. A green indicator bar, for instance, would reflect that for the particular task time remains to complete the particular task whereas a red indicator bar would indicate that the task is due or the time to complete the particular task has passed. A yellow indicator bar could be used to indicate a cautionary status, i.e., a warning that the project due date is near but not passed.

In another embodiment, indicator bars 14, 16 may be color-coded to reflect a total project complete status. In an integration environment having a number of tasks to be completed to achieve complete integration, a green indicator bar may be used to indicate overall project completion. A red indicator may be used to warn that overall project completion is now due or past due and that immediate attention is needed. Again, a yellow or intermediate color could be used to indicate impending unfavorable status, i.e., provide a warning.

Still-referring to FIG. 1, the acquisitions central GUI 10 includes a customer relations indicator 18. Indicator 18 may be shaped as a bar and color-coded to operate similar to indicator bars 14 and 16 or, in an alternate embodiment, include a percent favorable value. The percent favorable value may be color-coded either red, yellow, or green to provide a further indication of customer feedback. GUI 10 further includes an acquisition date field 20, an acquisition region field 22, and an acquisition discipline field 24. Alternatively, fields 20-24 may be used to indicate a project start date, project end date, project discipline, and a supervisory office location. GUI 10 further includes a number of tools links 26 that upon selection of a link, a user will be transferred to a new GUI such as a training materials GUI, a corporate news GUI, or a contact us GUI.

GUI 10 further includes a number of text lines 27 that may be used to display general company notes regarding the acquisition central process and/or general comments regarding the information displayed on GUI 10. GUI 10 further includes a company home tab 28 that upon selection will transfer the user to a new GUI that operates as the “home page” for the company. A help tab 29 is also provided that links a user to one or more technical assistance GUIs that are configured to provide contact information for technical assistance. GUI 10 is further configured to display a readily identifiable company logo 11a. Additional navigational tabs (not shown) may be used to provide further navigable options to a user. The additional tabs may include tabs to internal as well as external GUIs or web pages that provide general information regarding a particular project, integration or company.

In an alternate embodiment, GUI 10 of FIG. 1 may include a pole identifier (not shown) that allows a user to customize GUI 10 to display information regarding integrations of a particular pole or region. For example, a user may wish to view the performance data based on a particular pole or global region rather than an integration-specific display of performance data. That is, by selection Asia as a region, for example, performance data associated only with the integration functions and tasks within Asia would be displayed on GUI 10. Additionally, a function selector (not shown) may also be implemented to allow the user to view the performance of each integration based entirely on the selected function. That is, in this embodiment, the user may select a function such as finance and view the completion and/or performance of finance-related issues within each integration.

In a further embodiment, GUI 10 may also include a special user drill-down menu (not shown) that enables special users, such as, integration and function leaders to identify their role in relation to a particular integration and thereby be automatically linked to an integration or function setup GUI. The GUIs associated with initializing or setting up a particular integration and/or function will be described shortly.

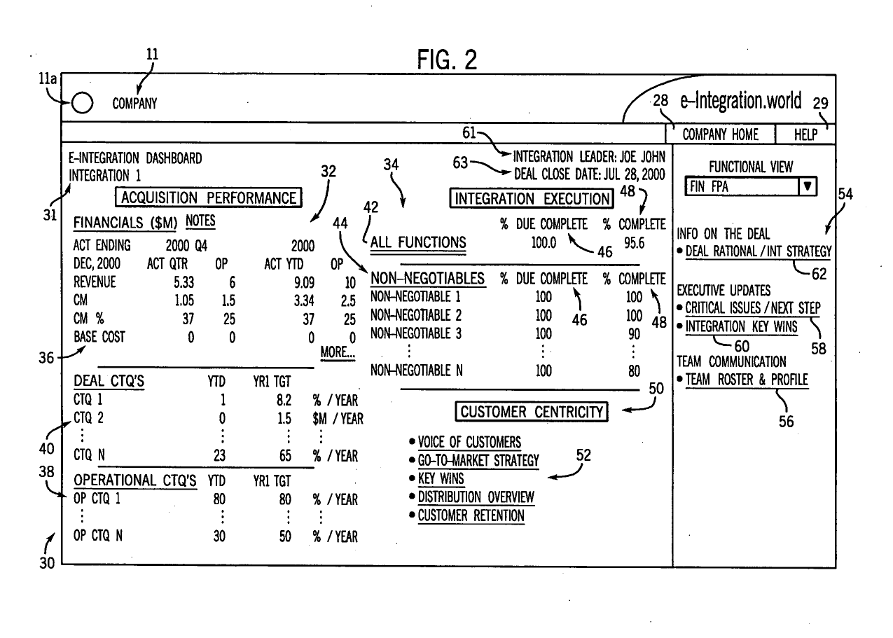

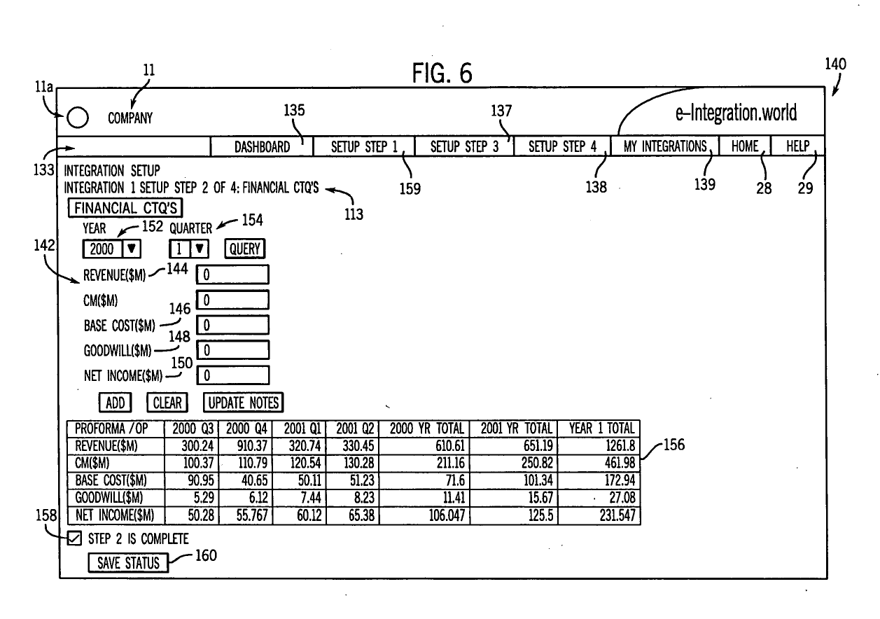

Referring now to FIG. 2, an integration-specific GUI 30 displays performance information for a particular integration or project 31. Access to GUI 30 occurs by user selection of one of the listed integrations 12 of GUI 10, FIG. 1. The performance indicators include a number of acquisition performance indicators 32 and a number of integration execution status indicators 34. The acquisition performance indicators 32 display financial and operational objectives 36, 38 as well as acquisition objectives 40. Preferably, the financial objectives 36 display financial data related to the acquisition of a recently acquired asset or enterprise. The financial objectives 36 are variable and are selected during integration initialization (to be discussed shortly). The financial objectives may include revenue information on a per quarter basis and year-to-date revenue data. Any measurable financial objective may be displayed provided the objective is initialized during integration initialization, as will be discussed with particular reference to FIG. 6.

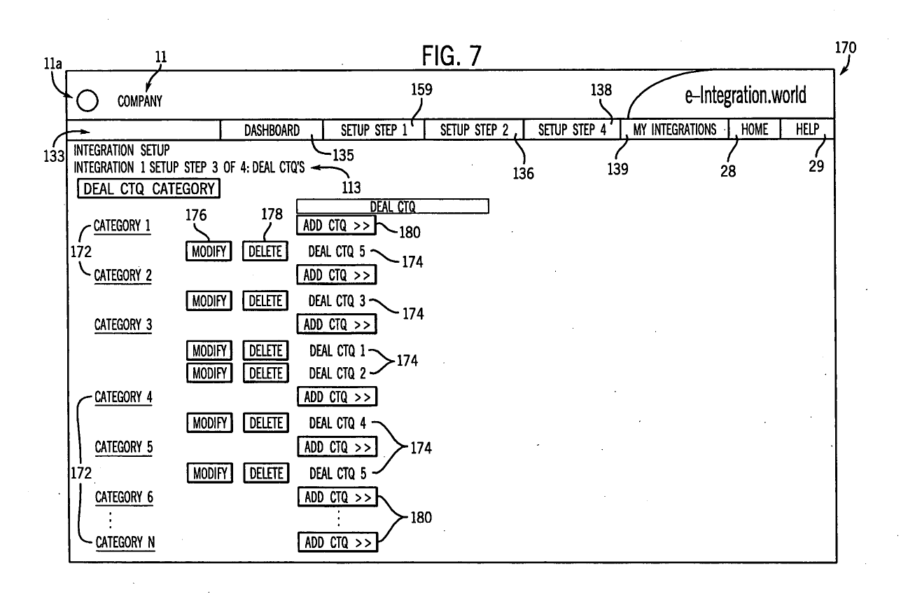

Operational objectives 38 include critical-to-quality (CTQ) goals that are sought to be achieved during the integration of the business enterprises. These Operational CTQs may include human resource related objectives, such as, a target retention of key personnel on a yearly basis. GUI 30 readily displays an indication of the progress toward satisfaction of that particular objective. As a result, a user, such as an integration leader, or business or department supervisor may monitor the progression of reaching the goal of retaining key personnel for the year without contacting an Operational leader or human resource manager directly. The Operational objectives are also variable and are selected during integration initialization as will be discussed with reference to FIG. 7.

Acquisition objectives, or deal synergies 40 include performance indicators that display a status of certain objectives to be achieved as a result of the acquisition of the enterprise. The acquisition objectives 40 or “Deal CTQs” might include market share targets, target sales in a particular global region, new order targets, and target increase in manufacturing. The status of these objectives 40 is shown as a Year-To-Date value with a year target value also provided. Again, the acquisition objectives 40 displayed on GUI 30 are arbitrary and established during integration initialization. Any acquisition objectives 40 may be displayed and monitored to determine acquisition performance.

Integration execution status indicators 34 include a number of tasks and/or projects to be completed as part of the asset or enterprise integration. In a preferred embodiment, an “All Functions” listing 42 is displayed as well as a list of non-negotiable functions 44. Corresponding to each listing 42, 44 is a due complete indicator 46 and a complete indicator 48. Due complete indicator 46 indicates the percent of a function that is completed as of the viewing date. A due complete indicator 46 having a value of 100% represents that the tasks of a particular function due by the viewing date are, in fact, complete. Conversely, a value of 50% indicates that only half of the tasks to be completed by the viewing date are completed. Complete indicator 48 provides an indication of the percent satisfaction of all projects associated with a particular function. For example, a value of 85% corresponding to the complete indicator 48 would indicate that 85% of the total number of all projects for a particular function have been completed regardless of due date.

GUI 30 includes a text section 50 that includes a number of customer related links 52. Preferably, the links 52 include a customer feedback link, a market strategy link that upon selection, a browser will be able to access information regarding market strategy from a potential or existing customer perspective, and additional customer centric links. Customer related text section 50, however, is proprietary and is not designed to be accessible by customers. Text section 50, however, merely provides a forum to provide critical information to facilitate the development and communication of a particular market strategy. For example, clients or customers secured after acquisition and during integration may be listed as well as facts surrounding the retention of the new client may be detailed in the customer related text section 50. Further, selected responses from customers/clients associated with a particular integration may be available for review, reply, and comment.

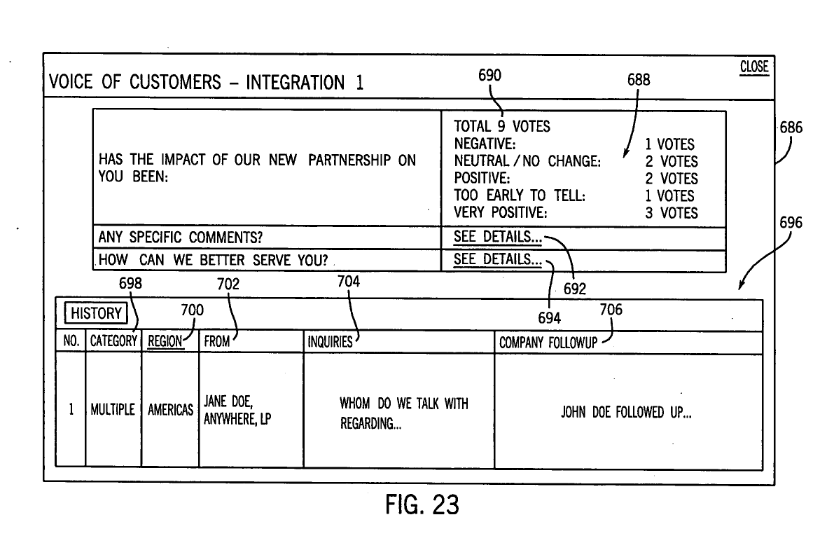

In an alternate embodiment, text section 50 may display a summary of consumer opinion regarding the integration. In this embodiment, a number of positive, neutral, and negative responses are shown for a given time period, such as the past thirty days. Moreover, a graphical presentation may be used to depict the summary feedback data. That is, a histogram may be used with favorable totals shown in green, neutral in yellow, and unfavorable in red. A hyperlink may also be provided that upon user selection displays another GUI configured to display more detailed information regarding integration related consumer feedback as will be discussed with reference to FIG. 23.

GUI 30 further includes a number of general integration links 54. Links 54 include a team roster and profile link 56 that enables viewing of personnel associated with a particular integration, project, or task. Links to a number of executive updates are further provided including a critical issues/next steps hyperlink 58 and an integration key wins hyperlink 60. Information regarding the rationale or strategy behind a particular Deal acquisition or integration may be accessed upon selection of a corresponding hyperlink 62. An integration leader identifier 61 as well as an acquisition close date identifier 63 are also provided. A consolidation date identifier (not shown) may also be provided.

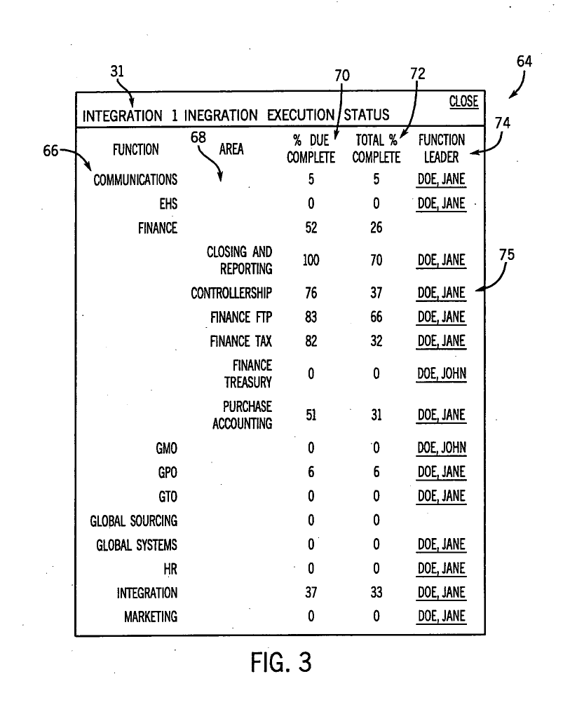

Shown in FIG. 3 is a functions GUI 64 for the previously selected integration 31. GUI 64 is accessible upon selection of the “All Functions” indicator 42 of FIG. 2, and is configured to display a listing of each function associated with the selected integration. For each function identified 66 a function area 68 is also displayed. The function area may indicate a particular function discipline, i.e., purchasing or controllership, or a particular office location responsible for completion of the particular function. A “% due complete” indicator 70 and a “total % complete”indicator 72 are further provided for each function. A function leader identifier 74 is also provided for each function. A pointer selection of a project leader 75 automatically activates an electronic messaging system that enables the user to send an electronic message to-the function leader 75 without separately opening an editing system and independently recalling and entering the function leader's mailing address.

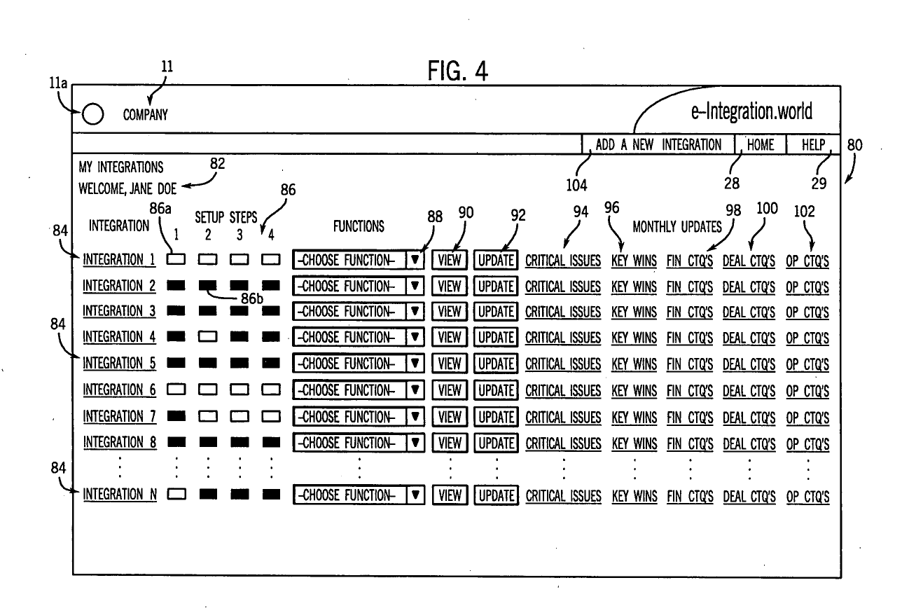

FIGS. 1-3 represent a network of GUIs that permit monitoring of one or more business acquisition integrations. Alternatively, the network of GUIs represented in FIG. 1-3 may also be utilized to monitor performance status of a number of projects and/or tasks. Utilization of the GUIs, however, is not possible until a number of initialization steps are completed. Initialization of a business acquisition integration will be discussed with particular reference to FIGS. 4-13.

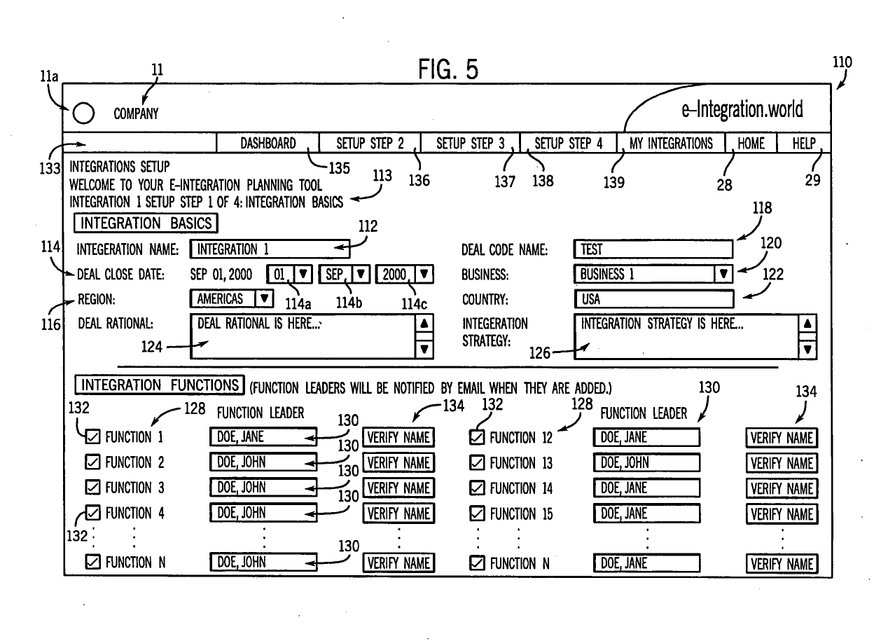

Shown in FIG. 4 is an integration initialization GUI 80. GUI 80 is the working environment for an integration leader 82 or integration initiator to add or modify an active integration. GUI 80 includes a hyperlink indicator 84 for each active integration. Corresponding to each integration hyperlink indicator 84 is a number of initialization indicators 86 which are color-coded to indicate a completion of a particular initialization step. As shown in FIG. 4, each integration hyperlink indicator 84 has four initialization indicators 86 associated therewith. The initialization steps associated with each initialization indicator 86 will be discussed with particular reference to FIGS. 5-12. As each initialization step is completed a corresponding initialization indicator 86 changes color. For instance, an incomplete initialization step may be represented by a white initialization indicator 86a, whereas a completed initialization step may be represented by a black initialization indicator 86b.

GUI 80 is the working environment to view or update a particular function of an active integration. To view or update an integration function a integration leader chooses a particular function of the active integration using drop-down menu 88. Each function associated with the active integration will then appear thereby allowing the integration leader 82 to drill down the menu and choose a particular function in which he or she wishes to view and/or update. After selecting a particular function of the active integration, the integration leader 82 may view the particular function and its associated attributes by selecting the view tab 90 associated with the active integration. Further, if the integration leader desires to update the selected function, the integration leader may do so by selecting update tab 92. By selecting the update tab 92, the integration leader 82 may update the projected completion date, assign a new function leader to the selected function, and alter additional parameters associated with the selected function.

GUI 80 further includes a number of integration specific hyperlinks that enable the integration leader, upon selection of a particular hyperlink, to update selected parameters of a particular integration. For example, GUI 80 includes a critical issues hyperlink 94, a key wins hyperlink 96, a financial CTQ hyperlink 98, a Deal CTQ hyperlink 100, and an Operational CTQ hyperlink 102 for each integration 84. Additionally, a voice-of-the-customers link (not shown) may be provided that enables viewing and updating of customer entered information regarding a particular integration. In a preferred embodiment, the integration leader may update each of the associated integration parameters as needed on a monthly basis. Through regular updating of each operating parameter for the selected integration, monitoring and project oversight of a particular integration and/or project is possible. As each integration operating parameter is updated, GUI 30, FIG. 2, will display the updated information appropriately. If the integration leader 82 desires to add a new integration, the integration leader 82 may select the “adding new integration” tab 104. The steps associated with adding new integration will be discussed with particular reference to FIGS. 5-12.

Referring now to FIG. 5, a first integration initialization GUI 110 is shown and includes an integration name identifier 112 and an integration step identifier 113. GUI 110 further includes a Deal close date identifier 114 having a number of drop down menus that allow the integration leader to properly identify the Deal close date by day 114a, month 114b, and year 114c. GUI 110 further includes a region identifier 116, a Deal code name field 118, a business discipline identifier 120, and a country identifier 122. Text boxes 124, 126 are also provided and may be used by the integration leader to display comments regarding the particular integration. For instance, text box 124 may be used to display statements regarding the rationale behind a particular Deal or integration whereas text box 126 may be used to outline a particular integration strategy.

As the working environment for the first initialization step, GUI 110 includes a number of integration function selectors 128. Corresponding to each integration function 128 is a function leader field 130 wherein the integration leader may assign the function to a member of the integration team or personnel department. The integration leader may select the integration functions of the integration by placing a check or other mark 132 next to an integration function identifier 128. After selecting a particular integration function 128, 132 and identifying a function leader responsible for overseeing the selected integration function, the integration leader may verify the name of the identified function leader upon selection of a verification tab 134. By verifying the name of the function leader responsible for the integration function, the integration leader automatically notifies the function leader with an electronic message detailing the function leader's responsibility for the integration function. After the integration leader has input all necessary information on GUI 110 the first initialization step of the integration is complete and as a result the first initialization indicator 86, FIG. 4, will appropriately turn to green to reflect that initialization step 1 is, in fact, complete.

GUI 110 further includes a navigational bar having a number of navigational tabs to permit efficient integration leader navigation through the several GUIs of the navigational interface system. Specifically, a selection of dashboard tab 135 will link the integration leader to GUI 30 of FIG. 2. The integration leader may link to GUIs of subsequent initialization steps by selecting Step 2 tab 136, Step 3 tab 137, or Step 4 tab 138: The integration leader may return to GUI 80 of FIG. 4 by selecting the “My Integrations” tab 139. The integration leader may save the inputted information by selecting a save button (not shown). In an alternate embodiment, the present invention contemplates allowing the integration leader to list links to additional web pages or other sources the integration leader suggests as references for the integration team.

Referring now to FIG. 6, a GUI 140 is configured to permit completion of a second integration initialization step. With GUI 140 the integration leader establishes a number of financial goals or financial CTQ objectives 142. The Financial CTQs 142 represent financial targets to be achieved during and as a result of the integration. For instance, the Financial CTQs 142 might include a Revenue target 144, a Base Cost target 146, a Goodwill target 148, and a Net Income target 150. Preferably, the integration leader identifies the financial CTQ targets 144-150 for a given year 152 on a per-quarter-basis 154. Additional time and accounting periods may be used to accommodate a particular integration, project, or task. As the integration leader inputs the appropriate financial CTQs 144-150 for each accounting period and for each selected year, table 156 will display each value in a tabular format. After all financial information has been input, preferably for one fiscal year period, the integration leader “checks” box 158 signifying that initialization step 2 is complete. After initialization step 2 is complete, the integration leader, if desired, selects save tab 160 to store the inputted financial information. Accordingly, the financial information entered by the integration leader is saved in a database so that the financial information may be retrieved and manipulated as needed. GUI 140 also includes navigational bar 133 and data tabs 135, 137-139, but also includes Step 1 initialization tab 159 since the GUI 140 of FIG. 6 represents the working environment for the second initialization step. Step 2 initialization tab 136 of FIG. 5 is not included in the navigational bar 133 of FIG. 6.

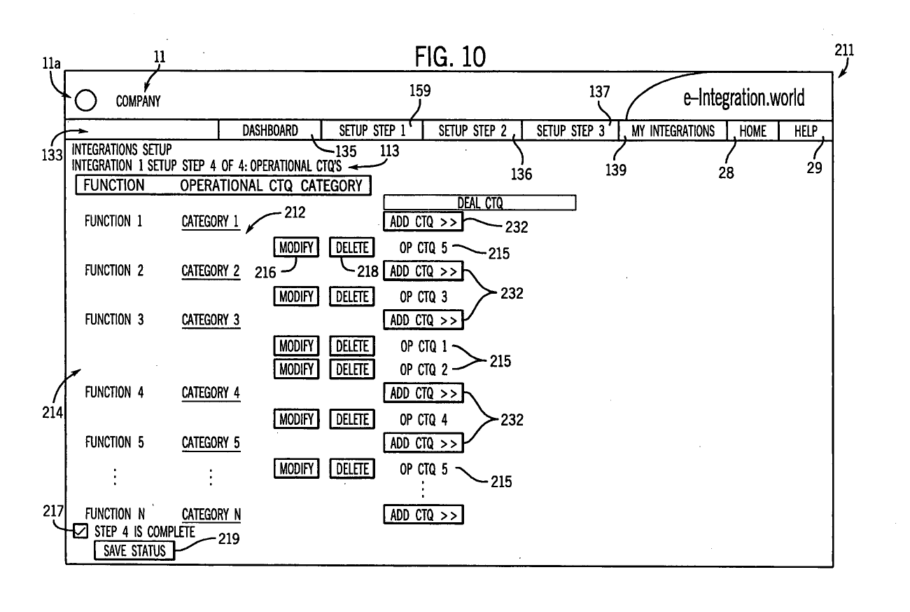

Referring now to FIG. 7, a third integration initialization GUI 170 is shown. GUI 170 is the working environment for the integration leader to identify a number of Deal CTQ targets. A number of Deal CTQ categories 172 identify a number of categories with associated CTQ targets the business integration seeks to achieve. For instance, a category 172 might represent a product goals category having a CTQ with a target to fill a particular product gap and provide customers with wider product offerings. Corresponding to each CTQ category 172 are a number of Deal CTQs 174. The Deal CTQs 174 represent a number of targets sought to be achieved during or as a result of the business acquisition. Corresponding to each Deal CTQ is a modify tab 176 and a delete tab 178 that allow the integration leader to modify or delete a number of parameters associated with the Deal CTQ 174, respectively. The operating parameters of a Deal CTQ will be discussed with reference to FIG. 9. Moreover, the integration leader may add a CTQ to a Deal CTQ category 172 by selecting the “Add CTQ” tab 180, as will be discussed with reference to FIG. 9.

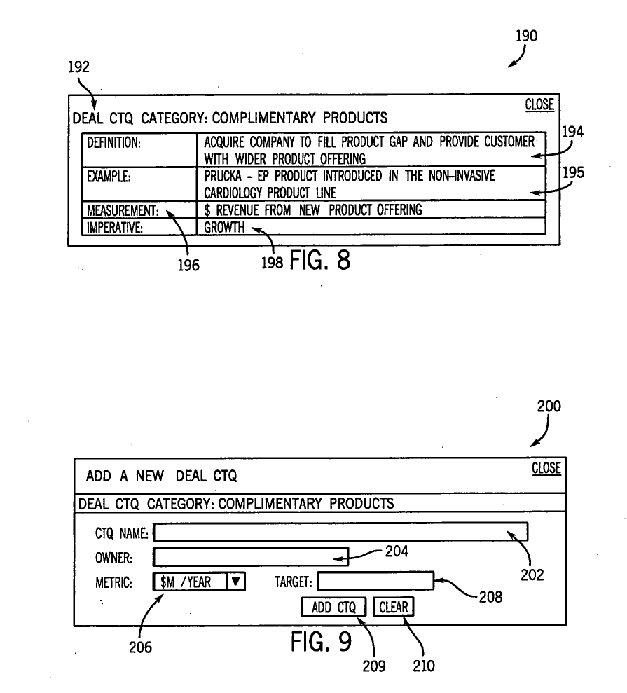

Shown in FIG. 8, is a definitional GUI 190 configured to display definitional information for a Deal CTQ category 172, FIG. 7. GUI 190 may be accessed by the integration leader with mouse pointer selection of CTQ category 172, FIG. 7. For example, GUI 190 is configured to display definitional information for a Deal CTQ category entitled “Complementary Products” 192. A definition associated with CTQ category 192 is provided in text box 194 and an example of a CTQ associated with the CTQ category 192 is provided in text box 195. Further, GUI 190 identifies a particular metric 196 that is often used to measure performance of a Deal CTQ. GUI 190 is further configured to display a Deal CTQ category imperative or discipline 198, i.e., the rationale behind the various Deal CTQs of the Deal CTQs category 172.

GUI 200, FIG. 9, appears upon an integration leader's selection to add a new CTQ 180 to a particular Deal CTQ category 172, FIG. 7. In adding a new Deal CTQ to a Deal CTQ category, the integration leader must provide a CTQ name 202 and assign an owner 204 who will be responsible for the satisfaction and/or completion of the new Deal CTQ. If applicable, the integration leader will further identify a metric 206, i.e., $ per year, and identify a target for the new Deal CTQ. After the operating information of the new Deal CTQ 172 has been added, the integration leader selects “Add CTQ” tab 209 to have the new CTQ automatically appear on GUI 170 of FIG. 7. The integration leader may clear information of the new CTQ by “clicking” tab 210. After each new CTQ has been added, if any, and modification and/or deletion of CTQs are complete, initialization step 3 is complete. As a result, the integration initialization indicator 86, FIG. 4, corresponding to the third initialization step will reflect that the third integration initialization step is, in fact, complete.

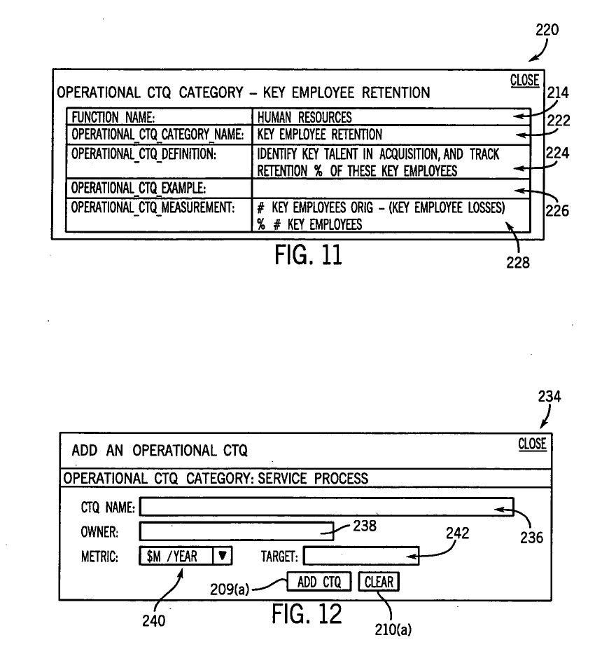

A fourth integration initialization step allows the integration leader to identify, modify, delete, or add Operational objectives or Operational CTQ targets in a manner similar to the initialization of the Deal CTQs as was discussed in reference to FIGS. 7-9. Referring now to FIG. 10, a fourth integration initialization GUI 211 provides a working environment for the integration leader to identify a number of Operational CTQ categories 212 related to the integration. The Operational CTQ categories 212 are arranged to be associated with a corresponding function 214 of the integration. Associated with each CTQ category 212 is one or more Operational CTQs 215. The integration leader may modify and/or delete an Operational CTQ 215 by “depressing” modify tab 216 or delete tab 218, respectively. After the integration leader has completed modification, deletion, and addition of Operational information, the integration leader marks “step 4 is complete” 217 and saves the information by “depressing” tab 219.

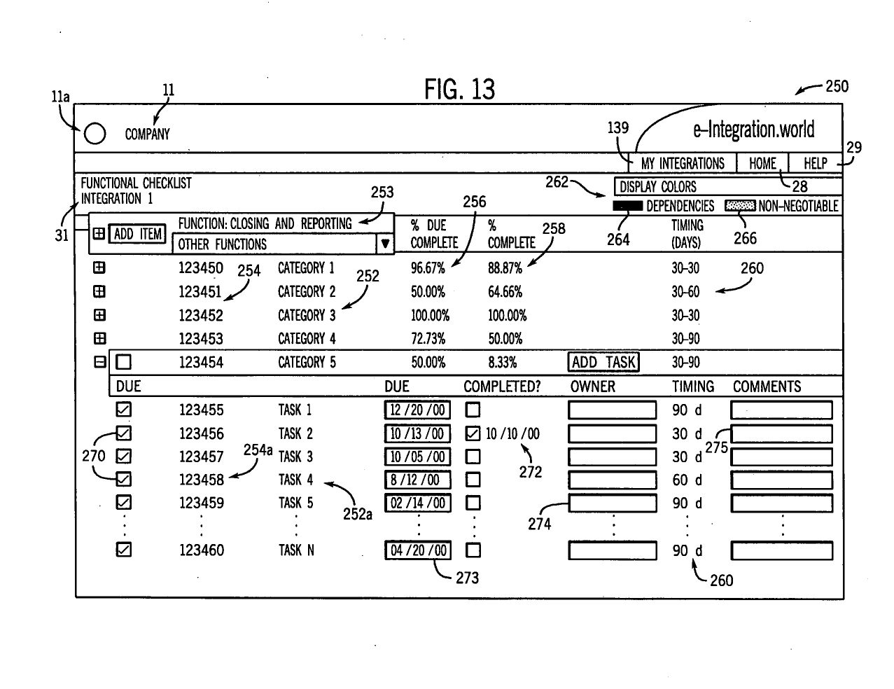

Shown in FIG. 11 is a descriptive GUI 220 that is accessed by the integration leader by selecting an Operational CTQ category 212 of FIG. 10. The integration leader can identify the category name 222, a definition 224 associated with the Operational CTQ, an example 226 of an Operational CTQ, an Operational CTQ measurement description 228 and a function 214 to which the CTQ corresponds. For instance, the Operational CTQ measurement 228 may be identified as the number of original key employees minus the number of key employee losses as a percentage of the number of key employees.

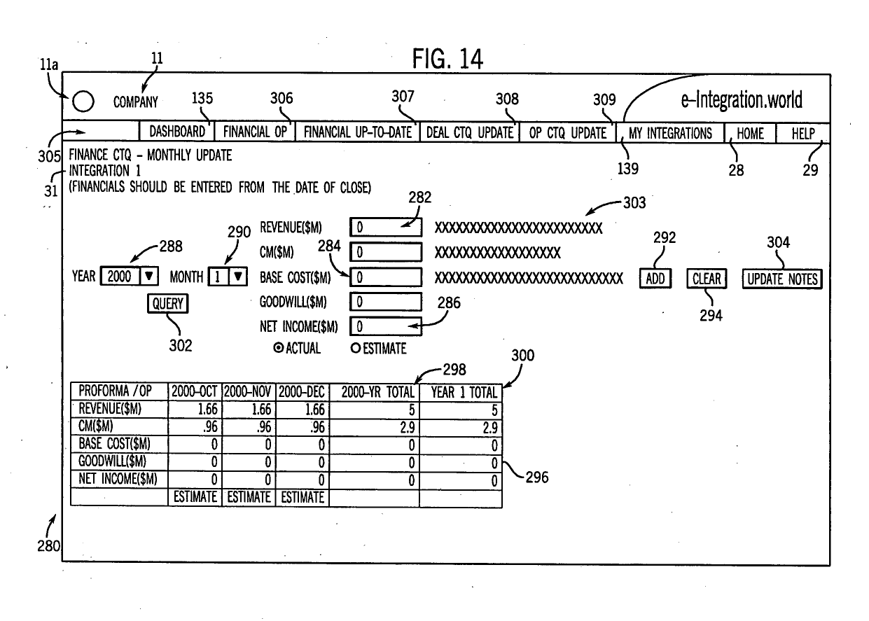

As indicated previously, the integration leader may add an Operational CTQ to an Operational category. To add an Operational CTQ to a particular Operational CTQ category the integration leader “depresses” button 232 of FIG. 10. As a result, the integration leader will be transferred to “Add an Operational CTQ” GUI 234 of FIG. 12. GUI 234 is the working environment for adding an Operational CTQ to an integration and allows the integration leader to identify a CTQ name 236, a CTQ owner 238, i.e., the person responsible for completing or monitoring the new CTQ, a metric value 240, and a target 242 for the CTQ in terms of the selected metric 240. Tabs 209(a) and 210(a) function similarly to tabs 209 and 210 of FIG. 9. As indicated previously, to complete the fourth integration initialization step the user marks box 217 of FIG. 10 and depresses “Save Status” tab 219. As a result, integration initialization indicator 86 of FIG. 4 corresponding to initialization step 4 will, in a preferred embodiment, turn to green to reflect completion of the fourth initialization step.

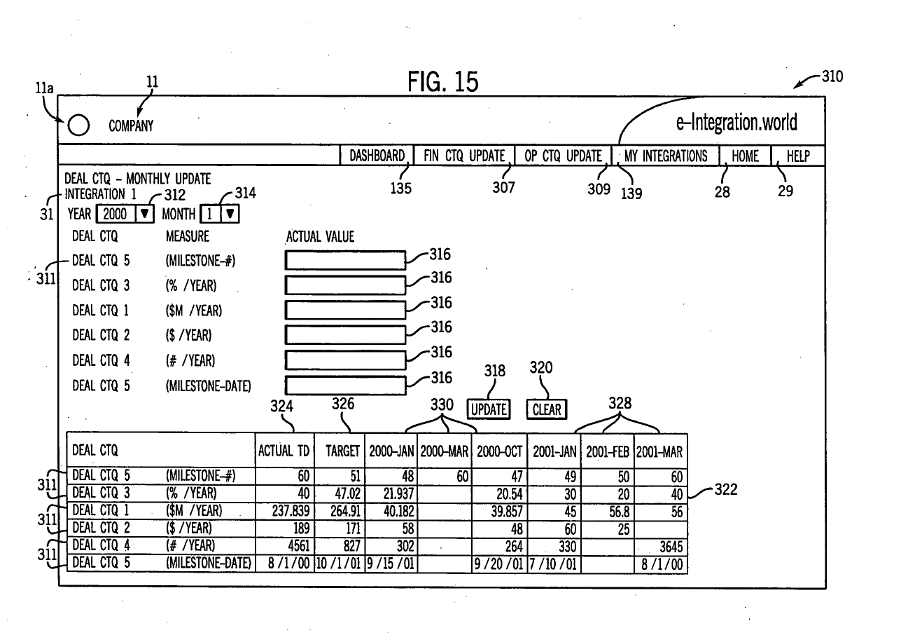

Referring to FIG. 13, a “Functional Checklist” GUI 250 is provided. GUI 250 is configured to display categories 252 of function 253. Corresponding to each category 252 is a category code 254, a “% Due Complete” value 256, a “% Complete” value 258, and a timing range indicator 260 configured to display the historical length of time typically required to complete the task. GUI 250 further includes a function legend 262 that, in a preferred embodiment, specifically identifies functions having dependencies 264 and functions that are non-negotiable 266, i.e., functions that must be included in the integration and cannot be deleted.

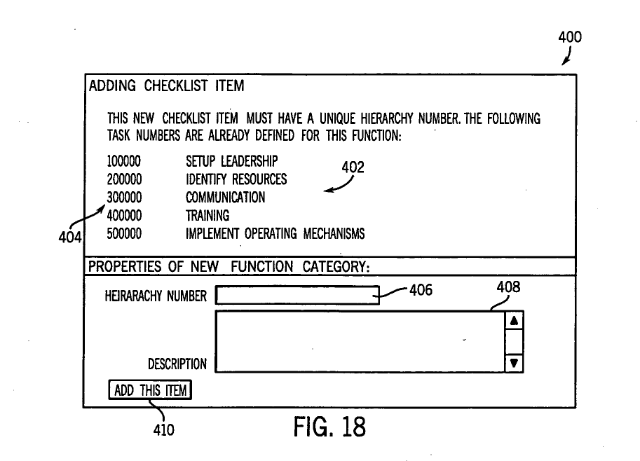

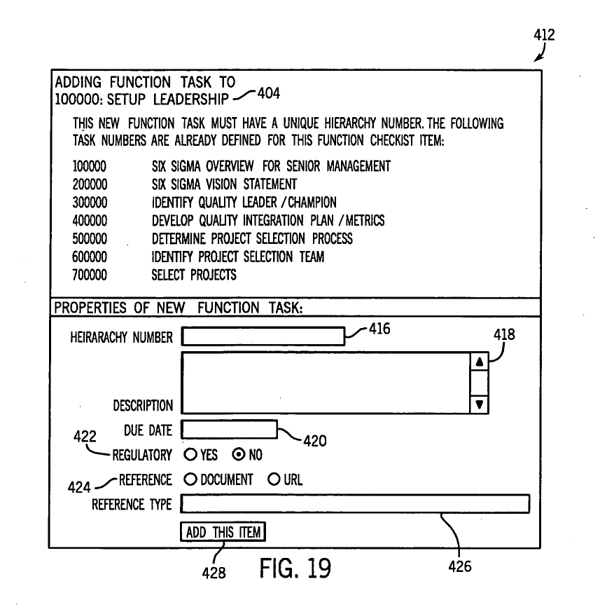

As indicated previously, the present invention allows for the automatic notification of function assignment to a function leader during integration initialization. After a function is assigned to a particular function leader, the function leader may access an integration specific functional checklist GUI 250, FIG. 13. GUI 250 provides the operating environment for a function leader to select and/or de-select task items 252a associated with a particular category 252 of the integration. Generally, a number of historical tasks will appear for potential selection by the function leader. The function leader may select one of the historical tasks 252a listed and by “checking” box 270 associated with the particular selected category 252. Since the historical tasks have been used before, a task code 254a will have been previously assigned to the task 252a. The function leader should identify a due date for the newly selected task in date field 273. The function leader should assign an owner to the new task in text field 274. The present invention allows the function leader to add informational comments for the new task in text field 275. The present invention further allows a function leader to add an entirely new task to-a function as will be discussed with reference to FIGS. 18-19.

A dependency relationship between tasks and functions is also contemplated. Essentially, a function and/or task of the integration may be effected by the completion or lack thereof of another function and/or task of the integration. As a result, the present invention includes the notification of completion to an independent task owner upon satisfaction of a dependent task. For example, a function leader may identify a particular task as complete by placing a check or other mark in a box 270 associated with a particular task. When the function leader identifies the task as complete, an electronic message is automatically, forwarded to another task leader who is responsible for a task that cannot be addressed until completion of the now completed task. Further, once a task has been completed and the function leader has marked the task as completed on GUI 250, the current date will automatically be entered in date field 272 corresponding to the newly completed task. The completion status of the particular task will automatically be reflected on GUI 30 of FIG. 2 and GUI 64 of FIG. 3. Since completion of the task indicates further completion of the particular integration, GUI 10 of FIG. I will also indirectly reflect completion of the task insofar as completion of the task represents movement toward completion of a particular integration 12.

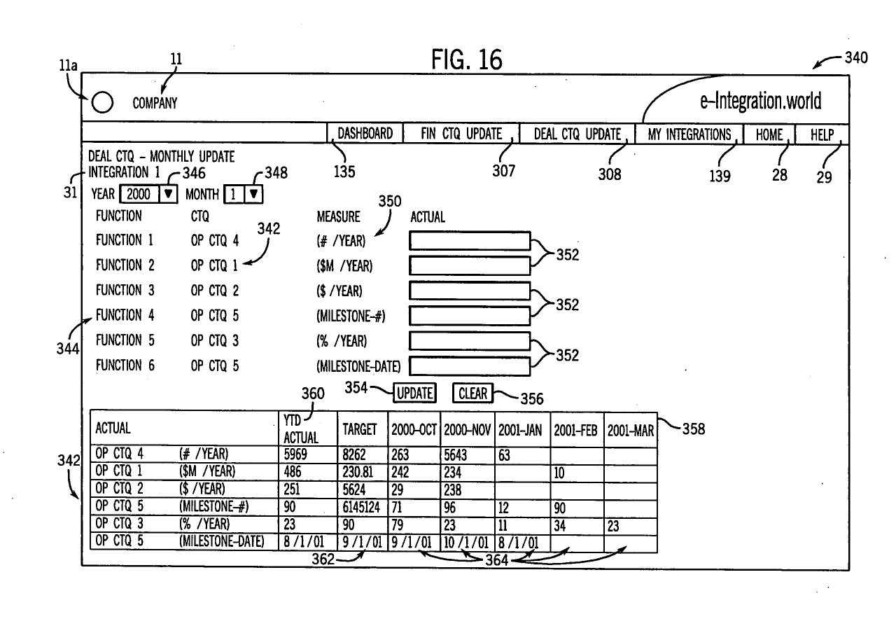

To facilitate accurate monitoring of integration performance and/or project completion, a number of additional GUIs, FIGS. 14-16, are provided, that permit the integration leader, or other individuals who have been given access, to update the various objectives and/or targets sought to be achieved during the integration. To provide the most accurate and up-to-date information, the integration leader and/or others should update the various objectives or targets at defined recurring intervals. Preferably, the various objectives and/or targets should be updated on an at least monthly basis. Furthermore, actual rather than estimated data should be used whenever possible to provide the most accurate indication of acquisition integration and/or project performance.

Referring now to FIG. 14, a monthly financial GUI 280 provides a working environment for an integration leader and/or acquisition finance manager to update financial data. At a minimum, actual monthly data should be used to provide the most accurate indication of integration performance. However, estimated monthly data may be used if actual monthly data is not available. GUI 280 permits the integration leader and/or acquisition finance manager to update several financial indicators of performance including revenues 282, base cost 284, net income 286, as well as additional financial data. GUI 280 allows the integration leader to select a year 288 and a month of that year 290 and add 292 and/or clear 294 data corresponding to the selected month and year. Table 296 is provided to display the corresponding month and year totals for financial objectives 282-286. The system is further designed to automatically calculate current year totals 298 as well as year 1 totals 300.

If the integration leader or finance manager seeks to supplement previously entered financial data, the integration leader may query the previously entered data by selecting a year 288 and a month 290 and then “depressing” query tab 302. As a result of selecting query tab 302, the stored financial information will appear in fields 282-286.

The integration leader or financial manager may provide notes and/or comments regarding the financial data in text section 303. Further, the integration leader or finance manager may update preexisting notes by querying a month/year of data, editing the notes corresponding thereto and selecting “update” tab 304 to store the edited remarks. GUI 280 further includes navigational bar 305 having a “dashboard” tab 135, a “financial op” tab 306, “financial up-to-date” tab 307, “Deal CTQ update” tab 308, “Op CTQ Update” tab 309, “My Integrations” tab 139, “Home” tab 28, and “Help” tab 29. The navigational bar 305 facilitates navigation between a number of updating GUIs of the navigational system.

FIG. 15 is similar to GUI 280 of FIG. 14 insofar as providing a working environment to update integration information. FIG. 15 includes GUI 310 for the monthly updating of Deal CTQs for an integration. In a preferred embodiment, GUI 310 is accessible only by the integration leader. By limiting access to GUI 310, errors associated with the accuracy of the updated information are reduced and/or eliminated. To update data for a CTQ 311, the integration leader selects a year 312 and a month 314 for which the to-be-entered data corresponds. An actual value field 316 is provided for each Deal CTQ 311 of the integration identified in field 31. To update a value associated with a particular CTQ 311, the integration leader enters an actual value in field 316 corresponding to the Deal CTQ 311. After the values for each Deal CTQ 311 has been entered, the integration leader confirms the information and then updates the information by “depressing” update button 318. Further, the integration leader may access previously entered data by choosing the appropriate year 312 and the appropriate month 314. When the data corresponding to the selected month and year appears in fields 316, the integration leader may clear or delete that data by “depressing” clear tab 320. GUI 310 further includes a table 322 that displays “a running total” for each Deal CTQ 311. In one embodiment table 322 is configured to display an actual to-date value 324 for each CTQ, a target value 326, as well as a number of specific monthly totals from the current year 320 and monthly totals for corresponding months of the previous year 330. It should be further noted that the system will automatically calculate the actual year-to-date totals for each Deal CTQ based on the data entered in fields 316.

Shown in FIG. 16 is an Operational CTQ updating GUI 340. GUI 340 is similar to GUI 310 of FIG. 15. GUI 340 provides a working environment for the integration leader to update Operational CTQs 342 of a number of integration functions 344 on a monthly basis. The integration leader may select a year 346 and a month of that year 348 for which updating is sought. Corresponding to each CTQ 342 is a measure indicator 350 and an actual data field 352 wherein the integration leader may input an actual value in terms of the identified measure 350 for the selected CTQ 342. After data for each CTQ 342 is properly entered in data fields 352, the integration leader may store the values by “depressing” update tab 354. Conversely, the integration leader may, by selecting a year 346 and a month 348, display the values associated with the selected year and month and clear the stored data by “depressing” clear button 356. Similar to table 322 of FIG. 15, GUI 340 includes display table 358 for displaying actual year-to-date values 360, target values 362, and monthly values 364 for each CTQ 342.

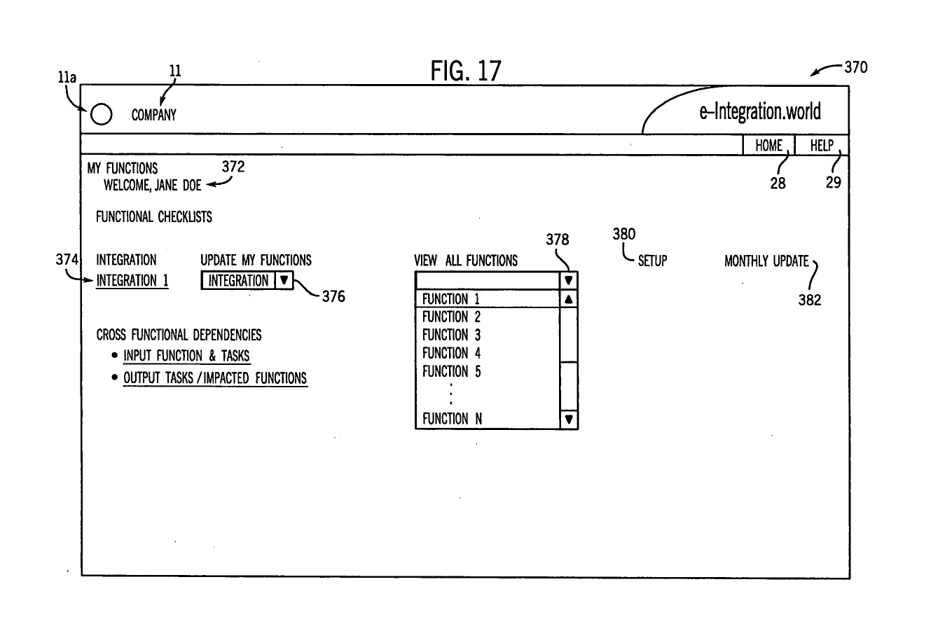

A function leader GUI 370 as shown in FIG. 17 is also provided. A function leader may be responsible for a number of functions for more than one active integration. Therefore, GUI 370 is configured to provide a working environment in which a function integration leader may update a particular integration function without accessing an integration specific update interface. Further, GUI 370 provides for an environment for the function integration leader to view the status of other function lists corresponding to other active integrations to which the function leader is responsible. Specifically, GUI 370 includes a function leader identifier 372 and a list of integrations 374 in which the function integration leader is involved. Corresponding to each integration 374 is a functions drop down menu 376 that displays each function associated with that integration. The drop down menu 376 only displays those functions which were assigned to the identified function leader during integration initialization. The function leader may also view all functions available for inclusion in the current integration using drop down menu 378.

Furthermore, a special user such as a business director/finance manager may, from GUI 370, initialize or set up a financial-targets for a particular integration. Initializing a new financial targets of the integration begins by “depressing” set up tab 380. Moreover, the authorized users may update from GUI 370 financial data/information for a particular integration by “depressing” tab 382. Set up and monthly update features 380, 382 allow the user to add new functions to the integration and/or modify current financial parameters of the integration without having to access an integration-specific update GUIs, such as those shown in FIGS. 14-16. For security purposes as well as ensuring the accuracy of financial data, the present invention contemplates the limiting of access to financial CTQ “set up” and “monthly updates” to finance leaders and integration leaders.

To provide additional control to a function leader over the particular functions for which he or she is responsible, additional interface windows as represented by FIGS. 18-19 are provided. Referring to FIG. 18, GUI 400 allows the function leader to add a category of tasks to a particular function. Preferably, each function category 402 is assigned a category number 404. When adding a new category for a function checklist, the function leader is required to enter a category number in field 406 and describe the new category in text box 408. After the new category number and the category description are provided, the function leader finalizes the addition of the new category by “depressing” tab 410.

Referring to FIG. 19, GUI 412 provides the operating environment for the function leader to add new tasks to category 404. GUI 412 is further configured to display the already existing tasks associated with the function category 404. To add a new function task, the function leader identifies a task number in field 416. A brief description of the task should also be provided in text box 418. Preferably, the function leader should identify an expected task completion date in field 420. To facilitate more efficient completion of the new task, the function leader should identify whether the task has any regulatory concerns 422, whether a particular reference 424 should be considered during and/or for preparation or completion of the task, and should identify the particular references in reference box 426. Upon entering the above information, the function leader selects button 428 to store the information and to insert the new function task into the appropriate checklist.

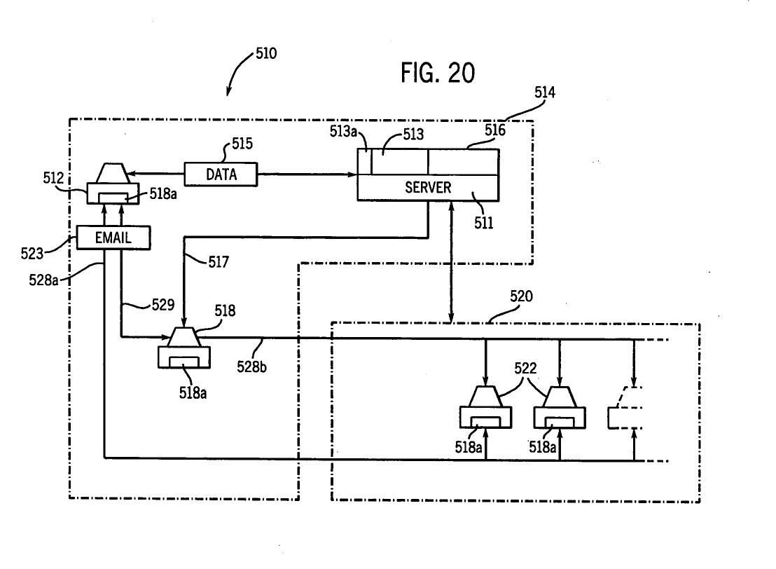

Referring to FIG. 20, a computerized system 510 for monitoring projects and consumer feedback relating thereto of a business integration includes a local area network (LAN) 514 and a wide area network (WAN) 520. Together the LAN 514 and the WAN 520 form an organizational intranet. The LAN 514 preferably includes a plurality of user terminals 512 for inputting integration/project/task data 515 into the system 510. The data 515 is routed to a server/computer 511 where it is stored in memory 513 as an electronic file. The server/computer 511 includes a processor 516 for processing data, search requests, routing data, and other such server functions. The server 511 is connected to a communications network 514 by a connection port 517 which connects the network to other terminals and workstations 518 in the local area. Each terminal and workstation is equipped with a monitor 518a. The terminals or workstations 518 are connected to the user terminal 512 via a connection link 529 such that the users of terminal 512 and terminal 518 can share data and other information via electronic mail 523 within the LAN 514.

The users of terminals 512, 518 in the network 14 may also be connected to remote users via a plurality of terminals 522 in the WAN 520 which may include numerous stand alone computers, terminals or workstations. Additionally, terminals 512 and 518 may be independently linked to the WAN 520 via links 528a, 528b which may include fiber optic lines, a direct modem link, or a global communications network, such as the World Wide Web view the Internet. This communications configuration allows users of the system 510 to remotely access the system 510 from many different locations, including sales offices, managers' office, human resources offices, or home offices, all of which may be located anywhere in the world.

Preferably, terminal or work station 518 is located in an integration or function leader's office where integration or function leaders provide information to the server 511 and the firm department personnel via terminals 518, 522.

System 510 is configured to allow for the sharing of data 515 in electronic form as saved in a database 513a. The information from the database 513a is displayed to the users at terminals 512, 518, and 522 in a number of graphical user interfaces (GUI) 558 consistent with the GUIs previously discussed in reference to FIGS. 1-19 representation. In the preferred embodiment, these graphical user interfaces take the form of a series of web page screens which have been constructed using a hypertext mark up language (HTML).

The present invention provides for a method and system of dynamically analyzing end-user or consumer feedback to determine a consensus of opinion regarding an implemented business plan or integration. The present invention allows a company or other enterprise to determine end-user opinion regarding a particular business decision by providing a number of GUIs that enable an end-user to input an opinion regarding the implemented business plan. The user may input objective, as well as subjective information regarding the business plan. The company may then analyze the objective data to ascertain a consensus regarding the implemented plan. Additionally, the present invention provides for routing of each response to the business plan or integration leader for evaluation. The business leader may continue to route the received response to additional personnel for follow-up or determine that the particular response is not in need of additional comment. The present invention also provides for displaying summary information of received and analyzed public opinion regarding the business plan thereby allowing personnel throughout the company to have an understanding of public opinion of the business plan. This enables personnel of a company to continuously monitor the impact of a business decision.

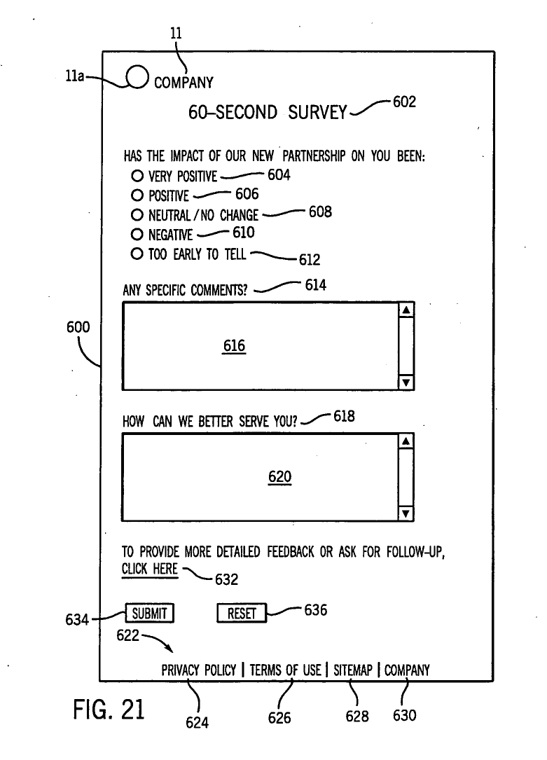

Now referring to FIG. 21, a survey GUI 600 is provided to enable an end-user to provide objective as well as subjective information regarding the impact of a recent business decision has had on the user. Survey GUI 600, in one embodiment, is entitled “60-Second Survey”, but the present invention contemplates the use of other titles to describe survey GUI 600. Title 602, in this embodiment, is so worded to properly reflect that the user's inputting of objective as well as subjective data regarding the business plan is not designed to be a lengthy and/or time-consuming endeavor. By providing a simple survey-like questionnaire for the user to complete, more users may be willing to spend the time to provide useful and meaningful feedback regarding the business plan. GUI 600 is designed to encourage user feedback and is designed such that feedback may be input easily and quickly. Specifically, GUI 600 allows the user to identify an objective opinion regarding the impact the new business plan is having on the individual or the institution. The user may identify the impact of the new business plan as one of: very positive 603, positive 606, neutral/no change 608, negative 610, and too-early-to-tell 612. Objective choices 604-612 are implemented for illustration purposes only. That is, the present invention contemplates the use of more or less objective choices for the user to select when identifying the impact of the implemented business plan. Choices 604-612 were selected to illustrate the gamut of opinion a user may have regarding the new business plan, but the present invention certainly contemplates variations thereof.

GUI 600 further enables the user to input any specific comments 614 in text box 616 regarding the impact the new business plan is having on the user. Text box 616 allows the user to expand or explain the objective opinion previously selected. GUI 600 also allows the user to identify how the company can provide better service 618 by inputting text in text box 620. Text box 620 enables the user to make suggestions and/or other remarks on how the company may satisfy the needs and/or concerns of the user in light of the recent implemented business plan. As will be discussed shortly, the objective selection, as well as the subjective comments and entered in text boxes 616-620 will be directed to a business plan leader for review.

A number of hyperlinks 622 are also provided that upon user selection will provide the user with additional general company information. Although not exhaustive, links 622 may include a privacy policy link 624, a terms of use link 626, a site map link 628, and a company copyright notice 630. Since GUI 600 is available to the general public for viewing and the inputting of feedback, links 622 are provided to link the user, upon selection, to the rights and responsibilities associated with GUI 600 and other general legal obligations.

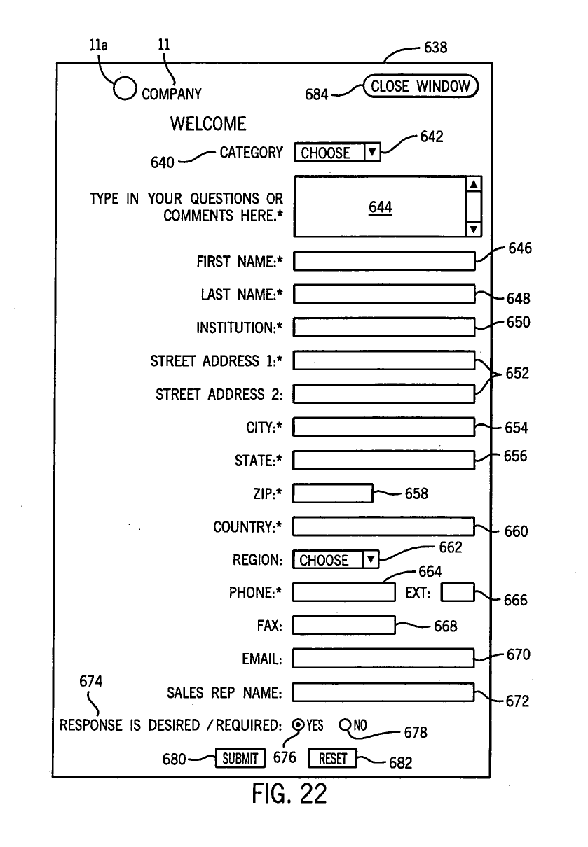

GUI 600 further includes a link to a junior GUI as will be discussed with reference to FIG. 22. As will be set forth below, the junior GUI allows the user to provide detailed feedback or ask for a follow-up reply by selecting link 632. Once the user has input an objective selection 604-612 and provided any specific comments 614 or suggestions 618 in text boxes 616-620, the user may authorize transmission of the entered feedback to a centralized facility of the company 11 by clicking submit button 634. User depressing of submit button 634 will authorize transmission of the information to the company and will further cause GUI 600 to close whereupon a general appreciation or “Thank You” GUI (not shown) will appear. A reset tab or button 636 is also provided to allow the user to clear any input responses without having to delete each entry individually. Selection of an objective choice 604-612 followed by a subsequent and new selection of objective choice 604-612 will automatically override the first objective selection. For example, an initial selection of “positive” 606 followed by a user selection of “very positive” 604 without any further changes will result in a “very positive” indication being transmitted to the centralized facility upon depressing submit tab 634.

Referring to FIG. 22, GUI 638 is viewable to the user upon user selection of hyperlink 632, FIG. 21. GUI 638 is configured to allow the user to provide more detailed feedback and/or ask for a follow-up to any questions and/or comments. GUI 638 enables the user to identify a subject 640 of the integration to which the questions and/or comments will be directed. In one embodiment, the user may use drill down menu 642 to select one of the following subjects: service, sales, products, or multiple. Selection of “multiple” as the subject indicates that the questions and/or comments pertain to more than one subject area. Furthermore, the aforementioned list of potential subjects is for illustration purposes only and is not to be construed as exhaustive. The user may input questions and/or comments in text box 644. As indicated earlier, the user is to direct the questions and/or comments to the subject area 640 selected using drill down menu 642.

To have the questions and/or comments properly processed and considered, the user is required to input personal contact information. The user is requested to input a first and last name 646, 648, an institution 650, a street address 652, a city 654, a state 656, and a zip code 660. The present invention contemplates receiving user feedback from a number of users residing in several countries, therefore, the user must identify a country of residence in field box 660. The user may also identify a region of residence or “pole” using drill down menu 662, i.e. Americas, Europe, or Asia. The user is next asked to input a telephone number with area code and country code, if applicable, in field box 664 and the user may input an extension 666, if applicable. Additionally, the user may identify a fax number 668 and an email address 670 as desired for response. The user may input the name of a sales representative in text box 672. Depending upon the questions and/or comments entered in field 644, addressability of the user's concerns may be expedited by providing the sales representative who generally services the identified institution 650.

GUI 638 further allows the user to indicate whether a response to the inputted questions and/or comments is desired/required 674. If a response is desired/required, the user may select “YES” selector 676 and if not select “NO” selector 678. In furtherance of the company's desire to respond to its customers needs, YES selector 676 is selected by default. By depressing submit tab 680, the user can authorize transmission of the contact information, as well as questions/comments and the request for response to the centralized facility for processing and analysis. The user may also clear each field 644-672 by depressing reset button 682. Depressing reset button 682 allows the user to delete all inputted data without deleting the text in each field individually. If the user decides not to submit additional questions/comments nor request a response to the comments and suggestions provided in text boxes 616 and 620 of FIG. 21, the user may select close window tab 684. Depressing close window tab 684 closes GUI 638 and causes GUI 600, FIG. 21, to be displayed. Furthermore, user selection of submit tab 680 will cause GUI 638, as well as GUI 600, FIG. 21, to be no longer visible to the user. As a result of the user's submission of the input data, the aforementioned appreciation/thank you GUI will be displayed to the user.

Once user feedback is submitted by the user for processing, the feedback will be analyzed to determine its characteristics. That is, the feedback will be analyzed to determine if the user provided a positive, very positive, too early to tell, neutral/no change, or negative response. Once the appropriate characteristic has been determined, the user's characterization of the impact of the implemented business plan is then tallied or added to a corresponding total. The positive, neutral, or negative vote totals are automatically updated for each received user response and are viewable on the integration specific dashboard, FIG. 2, as was previously discussed. Further, GUI 10 of FIG. 10 is automatically updated to reflect the addition of a positive, neutral, or negative user response.

Referring to FIG. 23, GUI 686 is viewable by integration personnel and other authorized users upon selection of the “voice of customers” hyperlink 52 in customer centricity section 50 of FIG. 2. As shown, GUI 686 maintains a running total of the number of received negative, neutral/no change, positive, too early to tell, and very positive votes generally referenced 688 in real-time or near real-time. A total vote indicator 690 is also provided to display the total number of votes received. GUI 686 allows viewing of specific comments entered by a customer as well as remarks on how the company can better serve the customer by depressing hyperlinks 692 and 694, respectively. Selection of hyperlinks 692 or 694 will cause selected representative comments/suggestions to be available for viewing. That is, an integration leader may have excerpts from selected user responses displayed on subsequent GUIs so that integration personnel and other viewers of GUI 686 may get an idea as to the general comments and/or suggestions that are being submitted to the company. Additionally, GUI 686 allows for viewing of selected user responses in text section 696. Although each received user response relating to the particular integration may be displayed for viewing, the present invention contemplates selective presentation of consumer responses. The present invention contemplates the integration leader or other authorized individual being able to select specific user responses for display on GUI 686.

For each displayed user response 696, basic identification information is provided as well as the specific user remark or inquiry. That is, a category 698, a region 700, and an author 702 is provided for each displayed user response. The category 698, region 700, and author 702 coincide with the inputted data provided by the user in text fields 642, 662, and 646-650 of GUI 638, FIG. 22. For each displayed user response, the specific inquiry 704 of the user entered in text box 644 of FIG. 22 is provided. The present invention contemplates the display of the user's complete text as entered in text box 644 of FIG. 22, but also contemplates the display of only a portion of the text. As shown in FIG. 23, GUI 686 further provides a follow-up section 706 that will display, if any, the company's follow-up to the user's inquiry(ies) 704. Follow-up section 706 allows viewers of GUI 686 to be informed as to whether any reply has been provided by the company to the user. Not only does follow-up section 706 provide specific relief to the user inquiry of 704, but also provides viewers of GUI 686 the opportunity to discern how the company addresses particular user inquiries. Additionally, the inquiries 704, as well as the company follow-up 706 may be able to provide insight to future growth opportunities within the marketplace for the company.

Further, timely analysis of end-user feedback enables the company to create a new business plan or modify an existing one. Evaluating end-user feedback in real-time allows a company to quickly determine market trends as well as ascertain a pattern of end-user likes and dislikes regarding the business plan. Moreover, the company is able to quickly assemble feedback response teams or relay information to other business groups, such as, sales divisions or customer service representatives. Real-time processing and evaluation of consumer feedback ultimately enables the company to quickly determine the needs of end-users and quickly create/implement business plans to satisfy those needs.

In accordance with an aspect of the present invention, a method of dynamically monitoring external responses to a business plan is provided. The method includes the step of providing a graphical user interface (GUI) that is configured to enable user input of feedback related to the business plan. The method further includes the steps of receiving user feedback wherein the user feedback includes one or more user responses and routing the user feedback to a centralized facility. At the centralized facility, feedback characteristics of the user feedback are determined for subsequent displaying on an internal business plan GUI and then actually displaying the feedback characteristics on the business plan GUI in near real-time.

In accordance with another aspect of the present invention, a network system having a computerized network, a readable memory electronically linked to the network, a plurality of computers connected to the network, and a processing unit capable of calling a number of graphical user interfaces (GUI) are provided to monitor consumer opinion of an implemented business integration. The system includes a processing unit programmed to display an external GUI having at least one user response link. The processing unit is further programmed to display, upon user selection of the at least one user response link, at least one response GUI including a survey GUI. The processing unit is further programmed to receive a user response regarding an implemented business integration and transmit the user response to an integration leader. Upon authorization by the integration leader, the processing unit is programmed to display the user response on a summary GUI for the implemented business integration.

In a further embodiment of the present invention, a computer data signal is provided and embodied in a carrier wave and representing a sequence of instructions that, when executed by one or more computers, causes the one or more computers to display a first GUI having at least two hyperlinks thereon, one of the hyperlinks configured to display a second GUI upon a user selection thereof and the other hyperlink configured to display a third GUI upon user selection thereof. The second GUI is configured to enable a user to input feedback regarding an impact of an implemented business integration and the third GUI is configured to enable the user to request a response to the feedback. The sequence of instructions further causes the one or more computers to route the feedback and any request for a response, to a business integration leader and display at least a summary of the inputted feedback on a business integration graphical dashboard.

The present invention has been described with respect to one or more active integrations and/or projects remotely and/or globally located from one another and thereby allowing, for review purposes, the centralization of performance data including consumer feedback opinions to ascertain project and/or integration performance. The present invention further contemplates, however, implementation with one or more “parent” integrations having one or more “child” integrations. That is, the present invention is fully applicable with the monitoring and evaluation of consumer feedback for integrations and/or projects having one or more subsidiary integrations and/or projects. The present invention contemplates the viewing of performance data for each parent integration or project as well as the individual viewing of performance data for each subsidiary integration for project.

The present invention has been described in terms of the preferred embodiment, and it is recognized that equivalents, alternatives, and modifications, aside from those expressly stated, are possible and within the scope of the appending claims.

What is claimed is:

1. A method of dynamically monitoring external responses to a business plan comprising the steps of:
providing a feedback inputting graphical user interface (GUI);
receiving user feedback on a business plan wherein the user feedback includes one or more user responses regarding the business plan;
routing the user feedback to a centralized facility;
at the centralized facility, determining feedback characteristics of the user feedback; and
displaying, in near real-time, the feedback characteristics on an internal business plan GUI.

2. The method of claim 1 wherein the feedback characteristics include at least one of a positive response, a negative response, and a neutral response.

3. The method of claim 2 further comprising the step of determining a total number of positive responses, a total number of neutral responses, and a total number of negative responses, and displaying the total number of positive responses, the total number of neutral responses, and the total number of negative responses on the business plan GUI.

4. The method of claim 1 further comprising the step of assigning at least one of a category, a region, a status, and an administrator to each user response.

5. The method of claim 4 further comprising the step of displaying, on the business plan GUI, the category, the region, a user response author, text of the user response, and, if any, a reply to the user response.

6. The method of claim 1 wherein the business plan GUI is accessible via one of an intranet, Internet, and extranet and is only viewable by an authorized user.

7. The method of claim 1 further comprising the step of routing the user feedback to a business plan leader and displaying the user feedback on the business plan GUI upon authorization of the business plan leader.

8. A computerized system for dynamically determining user response to an implemented business integration comprising:
a computerized network;
a readable memory electronically linked to the network;
a plurality of computers connected to the network wherein at least one of the plurality of computers display electronic data to a user in the form of a graphical user interface (GUI) and includes a processing unit programmed to:
display an external GUI having at least one user response link;
display, upon user selection of the at least one user response link, at least one response GUI including a user survey GUI;
receive a user response of an implemented business integration;
transmit the user response to an integration leader; and
display, upon authorization by the integration leader, the user response on a summary GUI for the implemented business integration.

9. The system of claim 8 wherein the processing unit is further programmed to determine if the user response is one of:
a very positive response;
a positive response;
a neutral/no change response;
a negative response; and
a too-early-to-tell response.

10. The system of claim 9 wherein the processing unit is further programmed to tally the user responses for each category and display the tally on the summary GUI.

11. The system of claim 9 further comprising a feedback GUI for the implemented business integration wherein access to the feedback GUI is limited to an authorized user and wherein the processing unit is further programmed to display each user response and, if any, a reply to a user response.

12. The system of claim 11 wherein the processing unit is further programmed to display a region, a modality, and an author for each displayed user response.

13. The system of claim 8 wherein the processing unit is further programmed to display a personal information GUI, the personal information GUI configured to allow a user to input contact information including a name, an address, a telephone number, a country, a zip code, a region, an email address, a sales representation name, and a request for a reply.

14. The system of claim 13 wherein the processing unit is further programmed to transmit the request for a reply to an integration leader.

15. A computer data signal embodied in a carrier wave and representing a sequence of instructions that when executed by one or more computers causes the one or more computers to:
display a first GUI having at least two hyperlinks thereon, one of the hyperlinks configured to display a second GUI upon a user selection thereof and another hyperlink configured to display a third GUI upon user selection thereof;
wherein the second GUI enables a user to input feedback regarding an impact of an implemented business integration;
wherein the third GUI enables the user to request a response to the feedback;
route the feedback and the request for a response, if any, to a business integration leader; and
display at a least a summary of the feedback on a business integration graphical dashboard.

16. The computer data signal of claim 15 wherein the sequence of instructions when executed further causes the one or more computers to display selected user feedback on a feedback summary GUI.

17. The computer data signal of claim 16 wherein the sequence of instructions when executed further causes the one or more computers to display a category, a pole, an author, an inquiry, if any, and an authorized response, if any, for each selected and displayed user feedback.

18. The computer data signal of claim 16 wherein the sequence of instructions when executed further causes the one or more computers to determine a total number of positive user responses, a total number of neutral user responses, and a total number of negative user responses and display the totals on the feedback summary GUI.

19. The computer data signal of claim 16 wherein viewing of the feedback summary GUI is limited to authorized users.

20. The computer data signal of claim 15 wherein the sequence of instructions when executed further causes the one or more computers to determine a total number of user responses received for a given period and display the total number of user responses for the given period on the business integration graphical dashboard.
